(19) United States
(12) Patent Application Publication
(10) Pub. No.: US 2025/0003775 A1
(43) Pub. Date: Jan. 2, 2025

(54) OPTICAL FIBER SENSING DEVICE AND METHOD

(71) Applicant: NIPPON TELEGRAPH AND TELEPHONE CORPORATION, Tokyo (JP)

(72) Inventor: Shingo ONO, Musashino-shi, Tokyo (JP)

(73) Assignee: NIPPON TELEGRAPH AND TELEPHONE CORPORATION, Tokyo (JP)

(21) Appl. No.: 18/689,685

(22) PCT Filed: Sep. 21, 2021
(86) PCT No.: PCT/JP2021/034518

§ 371 Date: Mar. 6, 2024

(51) Int. Cl. G01D 5/353; G01K 11/32

(52) U.S. Cl. CPC G01D 5/35329; G01K 11/32

(57) ABSTRACT

According to the present disclosure, there is provided an optical fiber sensing device including: a reference interferometer for producing a predetermined difference in propagation delay time in continuous light; a sensor interferometer including a plurality of Mach-Zehnder interferometers having unilateral optical paths functioning as sensor units; and a signal processing unit for performing signal processing by using a light reception signal I(t) obtained by receiving light transmitting through the sensor interferometer and a reference signal I_{ref-1}(t) obtained by receiving light transmitting through the reference interferometer, in which the signal processing unit calculates a cross-correlation Rⱼ between the light reception signal I(t) and the reference signal I_{ref-j}(t), and detects a change in the j-th sensor unit by using a change in the cross-correlation Rⱼ.

### TECHNICAL FIELD

The present disclosure relates to a field of optical fiber sensing techniques.

### BACKGROUND ART

An optical fiber sensor is a generic term for a system and a measurement technique for sensing a change in physical quantity such as temperature or distortion in association with a change in light intensity, frequency, or phase by using an optical fiber as a sensor medium. One of the optical fiber sensors is an interferometer-type optical fiber sensor. The interferometer-type optical fiber sensor uses a unilateral optical path of a Mach-Zehnder interferometer as a sensor unit, and performs sensing by using a phenomenon in which an intensity of an interference signal changes due to a change in the optical path length of the sensor unit due to temperature or distortion.

In addition, a multipoint interferometer-type optical fiber sensor that includes a plurality of interferometer-type connected optical fiber sensors and separately detects signals of individual sensors has also been developed. The multipoint interferometer-type optical fiber sensor uses a time domain division multiplexing mode, a wavelength domain division multiplexing mode, or a coherence domain division multiplexing mode depending on a difference in the division multiplexing mode for a plurality of sensor signals. Especially, the coherence domain division multiplexing mode is characterized in that each sensor signal can be constantly monitored and multipoint connection of sensors can be achieved without using a special optical device such as a wavelength division optical coupler.

An outline of a multipoint interferometer-type optical fiber sensor based on the coherence domain division multiplexing mode is as described in Non Patent Literature 1. Specifically, low coherence light is injected into sensor units in which a plurality of Mach-Zehnder interferometers are connected, transmitted light is split, and signals are separately detected by light-reception Mach-Zehnder interferometers corresponding to individual sensor units. In this regard, differences in propagation delay time between optical paths of the plurality of interferometers used in the sensor units are designed to be different from each other, and differences in propagation delay time between optical paths of the light-reception interferometers are designed to be equal to differences in propagation delay time between optical paths of the interferometers of the corresponding sensor units.

Given that the number of sensor units is N (N is a natural number), that an amplitude of a complex electric field of light emitted from a low coherence light source is E₀(t), and that an amplitude of a complex electric field of light transmitting through an i-th (i=1 to N) sensor unit is Eᵢ(t), a temporal average <Iⱼ(t)> of a light intensity detected by a j-th (j=1 to N) light receiver is expressed by the following expression.

$$\begin{matrix}[ Math . 1 ] & \\ 〈 {I}_{j} ( t ) 〉 ∝ \int {\vert {E}_{0} ( t ) + {E}_{0} ( t - {τ}_{j} ) + {\sum }_{i = 1}^{N} [ {E}_{i} ( t ) + {E}_{i} ( t - {τ}_{j} ) ] \vert}^{2} dt & ( 1 )\end{matrix}$$

Here, τⱼ is a difference in propagation delay time between optical paths of a j-th interferometer of the light receiver.

Given that a propagation delay time of the i-th sensor unit and an optical phase change due to a change in temperature or distortion are respectively τᵢ and Δθᵢ, Eᵢ(t) and <Iⱼ(t)> can be described as the following expressions.

$$\begin{matrix}[ Math . 2 ] & \\ {E}_{i} ( t ) = {e}^{j {Δθ}_{i}} {a}_{i} {E}_{0} ( t - {τ}_{i} ) & ( 2 )\end{matrix}$$

$$\begin{matrix}[ Math . 3 ] & \\ 〈 {I}_{j} ( t ) 〉 ∝ \int {\vert {E}_{0} ( t ) + {E}_{0} ( t - {τ}_{j} ) + {\sum }_{i = 1}^{N} {e}^{j {Δθ}_{i}} {a}_{i} [ {E}_{0} ( t - {τ}_{i} ) + {E}_{0} ( t - {τ}_{i} - {τ}_{j} ) ] \vert}^{2} dt ∝ 2 ( {\sum }_{i = 1}^{N} {a}_{i} + 1 ) Γ ( 0 ) + Γ ( {τ}_{j} ) + {\sum }_{i = 1}^{N} {a}_{i} [ 2 Γ ( {τ}_{i} ) + Γ ( {τ}_{i} - {τ}_{j} ) + Γ ( {τ}_{i} + {τ}_{j} ) ] cos {Δθ}_{i} & ( 3 )\end{matrix}$$

Here, aᵢ is a constant related to an amplitude of light transmitting through the i-th sensor unit. Γ(τ) is an autocorrelation function of E₀(t) and is defined by the following expression.

$$\begin{matrix}[ Math . 4 ] & \\ Γ ( τ ) ≡ \frac{1}{\sqrt{\int {\vert {E}_{0} ( t ) \vert}^{2} dt} \sqrt{\int {\vert {E}_{0} ( t + τ ) \vert}^{2} dt}} \int {E}_{0} ( t ) {E}_{0}^{*} ( t + τ ) dt & ( 4 )\end{matrix}$$

Here, the superscript * is a complex conjugate.
when a coherence time of E₀(t) is sufficiently short with respect to an available value of τ, Γ(t) can be regarded as the following expression.

$$\begin{matrix}[ Math . 5 ] & \\ Γ ( τ ) = \{ \begin{matrix}1 ( τ = 0 ) \\ 0 ( τ \neq 0 )\end{matrix} & ( 5 )\end{matrix}$$

Given that the expression (5) is substituted into the expression (3), in a region of τ>0, <Iⱼ(t)> is expressed by the following expression.

$$\begin{matrix}[ Math . 6 ] & \\ 〈 {I}_{j} ( t ) 〉 ∝ \{ \begin{matrix}2 ( {\sum }_{i = 1}^{N} {a}_{i} + 1 ) Γ ( 0 ) + {a}_{i} cos {Δθ}_{j} ( {τ}_{j} = {τ}_{i} ) \\ 2 ( {\sum }_{i = 1}^{N} {a}_{i} + 1 ) Γ ( 0 ) ( {τ}_{j} = {τ}_{i} )\end{matrix} & ( 6 )\end{matrix}$$

Therefore, the temporal average <Iⱼ(t)> of the light intensity detected by the j-th light receiver changes depending only on the optical phase change Δθⱼ in the sensor unit whose difference in propagation delay time matches with that of the interferometer. That is, the signals of the individual sensor units can be separately detected for each light receiver. Δθⱼ is in a relationship of the following expression with respect to a temperature change ΔTⱼ and a distortion change Δεⱼ in the j-th sensor unit.

$$\begin{matrix}[ Math . 7 ] & \\ Δ {θ}_{j} = {C}_{T} Δ {T}_{j} + {C}_{ε} Δ {ε}_{j} & ( 7 )\end{matrix}$$

Here, Cr and Ce are respectively proportional constants with respect to the temperature change and the distortion change. By obtaining the proportional constants C_{T} and C_{ε} in advance and substituting the expression (7) into the expression (6), it is possible to measure a change in temperature and distortion of the corresponding sensor unit.

### CITATION LIST

### Non Patent Literature

Non Patent Literature 1: J. L. Brooks, R. H. Wentworth, R. C. Youngquist, M. Tur, B. Y. Kim, and H. J. Shaw, “Coherence Multiplexing of Fiber-Optic Interferometric Sensors,” J. Lightw. Technol., Vol. LT-3, No. 5, pp. 1062-1072, 1985.

### SUMMARY OF INVENTION

### Technical Problem

In the multipoint interferometer-type optical fiber sensor in the related art based on the coherence domain division multiplexing mode, it is necessary to provide the Mach-Zehnder interferometers and the light receivers, for the light receiving unit, each of which is as many as sensor units. As a result, there is a problem that a configuration of the device becomes complicated and costly due to multipoint connection of sensor units. In addition, it is necessary to design the configuration such that the differences in propagation delay time between optical paths of the interferometers prepared in the light receiving unit match with the differences in propagation delay time between optical paths of the interferometers of the corresponding sensor unit, and this is not necessarily easy.

The present disclosure has been made in view of the above circumstances, and an object of the present disclosure is to provide a technique capable of realizing multipoint connection of sensors without complicating a device configuration and a design in a multipoint interferometer-type optical fiber sensor based on a coherence domain division multiplexing mode.

### Solution to Problem

According to the present disclosure, there is provided an optical fiber sensing device including:
a light source for outputting continuous light;
an optical coupler for branching the continuous light;
a reference interferometer, into which continuous light branched by the optical coupler is injected, for producing a predetermined difference τ_{ref} in propagation delay time in the continuous light;
a sensor interferometer, into which continuous light branched by the optical coupler is injected, including a plurality of connected Mach-Zehnder interferometers for producing, in the continuous light, differences in propagation delay time that correspond to integer multiples of the predetermined difference τ_{ref} in propagation delay time and are different from each other, the Mach-Zehnder interferometers having unilateral optical paths functioning as sensor units; and
a signal processing unit for performing signal processing by using a light reception signal I(t) which is obtained by receiving light transmitting through the sensor interferometer and a reference signal I_{ref-1}(t) which is obtained by receiving light transmitting through the reference interferometer,
in which the signal processing unit
calculates a reference signal I_{ref-j}(t) corresponding to a j-th (j is a natural number) sensor unit of the sensor units by using the reference signal I_{ref-1}(t),
calculates a cross-correlation Rⱼ between the light reception signal I(t) and the reference signal I_{ref-j}(t), and
detects a change in the j-th sensor unit by using a change in the cross-correlation Rⱼ.

According to the present disclosure, there is provided an optical fiber sensing method including:
branching continuous light from a light source;
injecting the branched continuous light into a reference interferometer producing a predetermined difference τ_{ref} in propagation delay time in the continuous light;
injecting the branched continuous light into a sensor interferometer, including a plurality of connected Mach-Zehnder interferometers, producing, in the continuous light, differences in propagation delay time that correspond to integer multiples of the predetermined difference τ_{ref} in propagation delay time and are different from each other, the Mach-Zehnder interferometers having unilateral optical paths functioning as sensor units; and
detecting, by a signal processing unit, a change in the sensor units by using a light reception signal I(t) which is obtained by receiving light transmitting through the sensor interferometer and a reference signal I_{ref-1}(t) which is obtained by receiving light transmitting through the reference interferometer,
in which the signal processing unit
calculates a reference signal I_{ref-j}(t) corresponding to a j-th sensor unit by using the reference signal I_{ref-1}(t),
calculates a cross-correlation Rⱼ between the light reception signal I(t) and the reference signal I_{ref-j}(t), and
detects a change in the j-th sensor unit by using a change in the cross-correlation Rⱼ.

### Advantageous Effects of Invention

According to the present disclosure, it is practical to realize multipoint connection of sensor units without using an interferometer on a light receiving side. Thus, multipoint sensing can be performed with a single device configuration regardless of the number of sensor units. Therefore, the present disclosure can realize multipoint connection of sensors without complicating a device configuration and a design in a multipoint interferometer-type optical fiber sensor based on a coherence domain division multiplexing mode.

### BRIEF DESCRIPTION OF DRAWINGS

FIG. 1 is a conceptual diagram of calculation of a phase X_{Mj}(t) of a reference signal in the present disclosure.

FIG. 2 is a block diagram illustrating a device configuration according to Embodiment 1 of the present disclosure.

FIG. 3 is a flowchart illustrating an implementation procedure according to Embodiments 1 and 2 of the present disclosure.

FIG. 4 is a block diagram illustrating a device configuration according to Embodiment 2 of the present disclosure.

### DESCRIPTION OF EMBODIMENTS

Hereinafter, embodiments of the present disclosure will be described in detail with reference to the drawings. Note that the present disclosure is not limited to the embodiments to be described below. These embodiments are merely examples, and the present disclosure can be implemented in forms in which various modifications and improvements can be performed based on knowledge of those skilled in the art. Note that components having the same reference numerals in the present specification and the drawings indicate the same components.

In the present disclosure, an optical signal transmitted through an interferometer of a sensor unit is received on a light receiving side without using an interferometer. Specifically, in an optical fiber sensing device according to the present disclosure, a reference interferometer, which transmits through an optical path different from an optical path of an interferometer of a sensor unit, is separately prepared, and a signal of each sensor unit before a change in temperature and distortion is generated in a pseudo manner by signal processing using a signal acquired from the reference interferometer. In the present disclosure, the signal generated in a pseudo manner is referred to as a reference signal. The optical fiber sensing device according to the present disclosure realizes a multipoint interferometer-type optical fiber sensor, without complicating a device configuration, by calculating a cross-correlation between the reference signal and a light reception signal acquired from the interferometer of the sensor unit.

When an interferometer is not used for the light receiving unit, a light reception signal I(t) acquired in regard to an optical path transmitting through N (N is a natural number) sensor units is represented by the following expression.

$$\begin{matrix}[ Math . 8 ] & \\ I ( t ) ∝ {\vert {E}_{0} ( t ) + {\sum }_{i = 1}^{N} {E}_{i} ( t ) \vert}^{2} & ( 8 )\end{matrix}$$

Here, E₀(t) is an amplitude of a complex electric field of continuous light before injection into the N sensor units, and Eᵢ(t) is an amplitude of a complex electric field of light transmitting through an i-th (i=1 to N) sensor unit. In the present embodiment, an example in which continuous light from a light source is injected into the N sensor units will be described.

Given that the expression (2) is substituted into the expression (8), the light reception signal I(t) is expressed by the following expression.

$$\begin{matrix}[ Math . 9 ] & \\ I ( t ) ∝ {\vert {E}_{0} ( t ) + {\sum }_{i = 1}^{N} {e}^{j Δ {θ}_{i}} {a}_{i} {E}_{0} ( t - {τ}_{i} ) \vert}^{2} ∝ {\sum }_{i = 1}^{N} {a}_{i} cos [ θ ( t ) - θ ( t - {τ}_{i} ) - Δ {θ}_{i} ] & ( 9 )\end{matrix}$$

Here, τᵢ is a propagation delay time in the i-th sensor unit, Δθᵢ is an optical phase change in the i-th sensor unit, and aᵢ is a constant related to an amplitude of the light transmitting through the i-th sensor unit.

Note that, here, θ(t) is a phase of the continuous light from the light source and a description of a DC component is omitted in a second row of the expression (9). In addition, it is assumed that an intensity of light which transmits through each sensor unit is sufficiently weak (aᵢ<<1) in comparison with an intensity of light which does not transmit through the sensor unit and that interference components between the light transmitting through the sensor units are negligible.

On the other hand, a reference signal I_{ref-1}(t) obtained from light transmitting through the reference interferometer is expressed by the following expression.

$$\begin{matrix}[ Math . 10 ] & \\ {I}_{ref - 1} ( t ) ∝ {\vert {E}_{0} ( t ) + {E}_{0} ( t - {τ}_{ref} ) \vert}^{2} ∝ cos [ θ ( t ) - θ ( t - {τ}_{ref} ) ] & ( 10 )\end{matrix}$$

Here, τ_{ref} is a difference in propagation delay time between optical paths of the reference interferometer.

Next, by using I_{ref-1}(t), a reference signal before a change in temperature and distortion of a j-th sensor unit is generated in a pseudo manner by numerical calculation. Assuming that a delay time τⱼ given to the optical path of the j-th sensor unit is designed to satisfy τⱼ=Mjτ_{ref} (Mⱼ is a natural number), it is only necessary to generate a cosine wave signal having θ(t)−θ(t−Mⱼτ_{ref}) as a phase component. Here, a phase X₁(t) in regard to Mⱼ=1 and a phase X_{Mj}(t) in regard to Mⱼ are defined as the following expressions.

$$\begin{matrix}[ Math . 11 ] & \\ {X}_{1} ( t ) ≡ θ ( t ) - τ ( t - {τ}_{ref} ) & ( 11 )\end{matrix}$$

$$\begin{matrix}[ Math . 12 ] & \\ {X}_{{M}_{j}} ( t ) ≡ θ ( t ) - θ ( t - {M}_{j} {τ}_{ref} ) & ( 12 )\end{matrix}$$

X_{Mj}(t) can be calculated by the following expression using X₁ (t).

$$\begin{matrix}[ Math . 13 ] & \\ {X}_{{M}_{j}} ( t ) = \{ \begin{matrix}{X}_{1} ( t ) ( {M}_{j} = 1 ) \\ {X}_{1} ( t ) + {\sum }_{k = 1}^{{M}_{j} - 1} {X}_{1} ( t - k {τ}_{ref} ) ( {M}_{j} > 1 )\end{matrix} & ( 13 )\end{matrix}$$

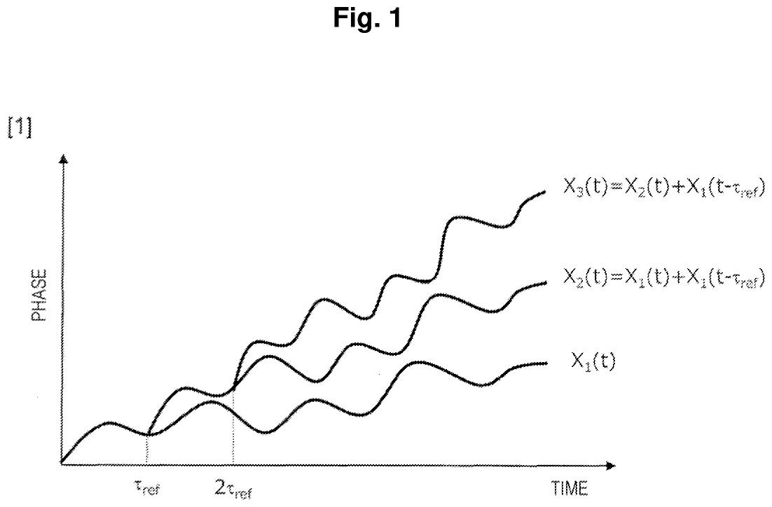

FIG. 1 is an image of calculation of X_{Mj}(t) by the expression (13) on condition of Mⱼ>1. X_{Mj}(t) is calculated by summing up Mⱼ waveforms obtained by shifting X₁(t) by τ_{ref} on a time axis. By using X_{Mj}(t), a pseudo reference signal I_{ref-Mj}(t) in regard to the j-th sensor unit is generated by the following expression.

$$\begin{matrix}[ Math . 14 ] & \\ {I}_{ref - {M}_{j}} ( t ) = cos {X}_{{m}_{j}} ( t ) = cos [ θ ( t ) - θ ( t - {M}_{j} {τ}_{ref} ) ] & ( 14 )\end{matrix}$$

Next, a cross-correlation R_{Mj} between cosine waves of I(t) and I_{ref-Mj}(t) is calculated. R_{Mj} is calculated by the following expression.

$$\begin{matrix}[ Math . 15 ] & \\ {R}_{{M}_{j}} = \int I ( t ) {I}_{ref - {M}_{j}} ( t ) dt = \frac{1}{2} {\sum }_{i = 1}^{N} {a}_{i} \int \{ cos [ θ ( t - {τ}_{i} ) - θ ( t - {M}_{j} {τ}_{ref} ) + {Δθ}_{i} ] + cos [ 2 θ ( t ) - θ ( t - {τ}_{i} ) - θ ( t - {M}_{j} {τ}_{ref} ) - {Δθ}_{i} ] \} dt = \frac{1}{2} {\sum }_{i = 1}^{N} {a}_{i} \int cos [ θ ( t - {τ}_{i} ) - θ ( t - {M}_{j} {τ}_{ref} ) + {Δθ}_{i} ] dt & ( 15 )\end{matrix}$$

Here, assuming that a coherence time of the continuous light from the light source is sufficiently shorter than τ_{ref} and the propagation delay times of the plurality of sensor units do not overlap each other, the following expression holds.

$$\begin{matrix}[ Math . 16 ] & \\ \int cos [ θ ( t - {τ}_{i} ) - θ ( t - {M}_{j} {τ}_{ref} ) + {Δθ}_{i} ] dt ∝ \{ \begin{matrix}cos {Δθ}_{j} ( {τ}_{i} = {τ}_{j} ) \\ 0 ( {τ}_{i} \neq {τ}_{j} )\end{matrix} & ( 16 )\end{matrix}$$

Given that the expression (16) is substituted into the expression (15), R_{Mj} is as follows.

$$\begin{matrix}[ Math . 17 ] & \\ {R}_{{M}_{j}} ∝ cos {Δθ}_{j} & ( 17 )\end{matrix}$$

Therefore, a magnitude of the cross-correlation R_{Mj} calculated in regard to Mⱼ satisfying τⱼ=Mⱼτ_{ref} changes depending on a change in temperature, distortion, and the like of the j-th sensor unit. Thereby, by monitoring a change in R_{Mj}, a change in temperature and distortion of the j-th sensor unit can be sensed. Similarly, a change in temperature and distortion of a certain i-th sensor unit, other than the j-th sensor unit, can be also sensed by monitoring a cross-correlation R_{Mi} calculated in regard to Mᵢ satisfying τᵢ=Mᵢτ_{ref}.

### Effects of Present Disclosure

By using the present disclosure, it is practical to realize multipoint connection of the sensor units without adding an interferometer or a light receiver of the light receiving unit in the multipoint interferometer-type optical fiber sensor. In addition, in the related art, it is necessary to design the configuration such that the differences in propagation delay time between the optical paths are equal to each other in the interferometer of the sensor unit and the interferometer of the light receiving unit. On the other hand, by using the present disclosure, it is not necessary to provide the interferometer of the light receiving unit. Therefore, a design of the light receiving unit can be simplified. Thereby, multipoint sensing can be performed with a single device configuration regardless of the number of sensor units. Therefore, optical fiber sensing can be realized with lower cost and higher expandability than those of the related art.

Embodiments of the present disclosure will be described with reference to the accompanying drawings. Here, two types of embodiments having different configurations of the sensor unit will be described.

### Embodiment 1

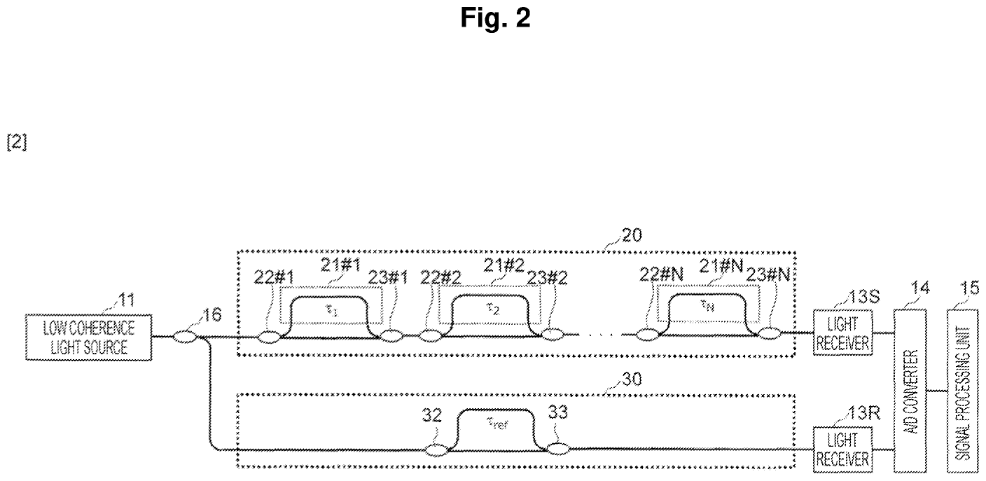

FIG. 2 is a block diagram illustrating a device configuration according to the present embodiment. A low coherence light source 11 is used as a light source, and continuous light output from the low coherence light source 11 is branched at an optical coupler 16 and is injected into a sensor interferometer 20 and a reference interferometer 30. The sensor interferometer 20 includes N sensor units 21 #1 to 21 #N. A light receiver 13S receives light from the sensor interferometer 20. A light receiver 13R receives light from the reference interferometer 30.

The reference interferometer 30 is a Mach-Zehnder interferometer in which a difference in propagation delay time between optical paths is τ_{ref}. The differences ti to IN in propagation delay time between optical paths of Mach-Zehnder interferometers of the sensor interferometer 20 are integar multiples of τ_{ref}, and do not overlap each other in a plurality of Mach-Zehnder interferometers (Mⱼ≠Mᵢ(j≠i)). In addition, as the low coherence light source 11, a light source having a coherence time shorter than τ_{ref} is used.

In the present embodiment, the sensor interferometer 20 has a chain type configuration in which a plurality of Mach-Zehnder interferometers are connected in series with optical couplers 22 #1 to 22 #N and 23 #1 to 23 #N, and unilateral optical paths of the Mach-Zehnder interferometers of the sensor interferometer 20 individually corresponds to the sensor units 21 #1 to 21 #N.

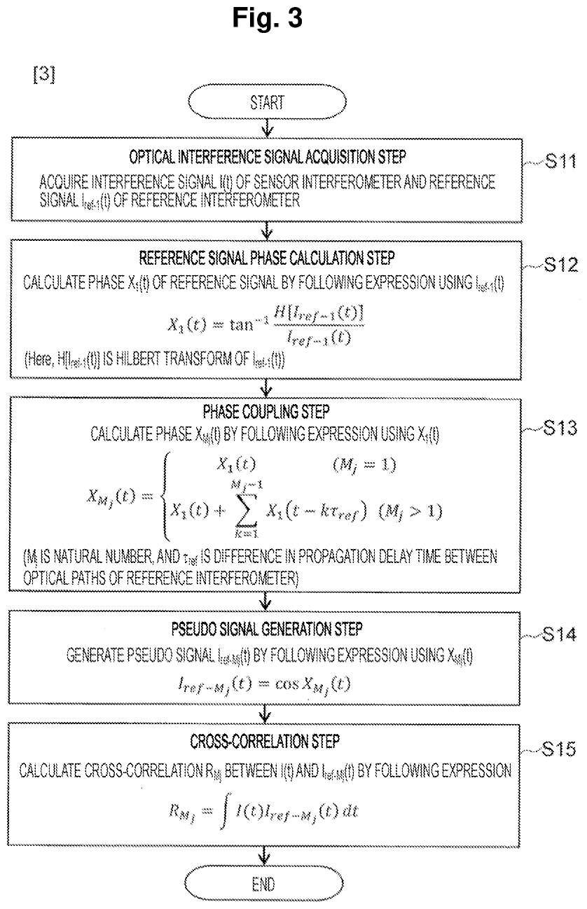

FIG. 3 is a flowchart illustrating an implementation procedure in the present embodiment. The implementation procedure includes an optical interference signal acquisition step S11, a reference signal phase calculation step S12, a phase coupling step S13, a pseudo signal generation step S14, and a cross-correlation step S15. Note that, here, an example where sensing is performed in regard to the j-th sensor unit 21 #i of the plurality of sensor units 21 #1 to 21 #N will be described.

In the optical interference signal acquisition step S11, optical interference signals are individually acquired by using two types of optical interferometers: the sensor interferometer 20 and the reference interferometer 30. Specifically, continuous light transmitted through the sensor interferometer 20 and continuous light transmitted through the reference interferometer 30 are respectively received by individual light receivers 13S and 13R, and are converted into electric signals. The light reception signals that are the electric signals obtained by the conversion are individually converted into digital signals by an A/D converter 14, and are transmitted to a signal processing unit 15.

The signal processing unit 15 calculates optical interference signals of the sensor interferometer 20 and the reference interferometer 30 by using the digital signals from the A/D converter 14. The digital signal obtained from the light receiver 13S is a light reception signal I(t), and the digital signal obtained from the light receiver 13R is a light reception signal I_{ref-1}(t).

Next, in the reference signal phase calculation step S12, the signal processing unit 15 calculates a phase X₁(t) by using the light reception signal I_{ref-1}(t) obtained in regard to the reference interferometer 30 of the two types of optical interference signals acquired in the optical interference signal acquisition step S11. X₁(t) can be calculated by the following expression using the signal I_{ref-1}(t) obtained for the reference interferometer 30.

$$\begin{matrix}[ Math . 18 ] & \\ {X}_{1} ( t ) = {tan}^{- 1} \frac{H [ {I}_{ref - 1} ( t ) ]}{{I}_{ref - 1} ( t )} & ( 18 )\end{matrix}$$

Here, H[I_{ref-1}(t)] is a Hilbert transform of I_{ref-1}(t), and H[I_{ref-1}(t)] is expressed as the following expression where I_{ref-1}(t) is expressed as the expression (10).

$$\begin{matrix}[ Math . 19 ] & \\ H [ {I}_{ref - 1} ( t ) ] ∝ sin [ θ ( t ) - θ ( t - {τ}_{ref} ) ] & ( 19 )\end{matrix}$$

Next, in the phase coupling step S13, X_{Mj}(t) is obtained by the expression (13) using X₁(t). Here, Mⱼ is a natural number that satisfies τⱼ=Mⱼτ_{ref} where the difference in propagation delay time between optical paths of the interferometers of the j-th sensor unit 21 #j is τⱼ.

Next, in the pseudo signal generation step S14, a pseudo signal I_{ref-Mj}(t) in regard to the j-th sensor unit 21 #j is calculated by the expression (14).

Finally, in the cross-correlation step S15, a cross-correlation R_{Mj} between the optical interference signal I(t) and the pseudo signal I_{ref-Mj}(t), which are acquired in regard to the sensor interferometer 20, is calculated. By monitoring a magnitude of the calculated R_{Mj}, a change in temperature and distortion of the j-th sensor unit 21 #j is detected.

### Embodiment 2

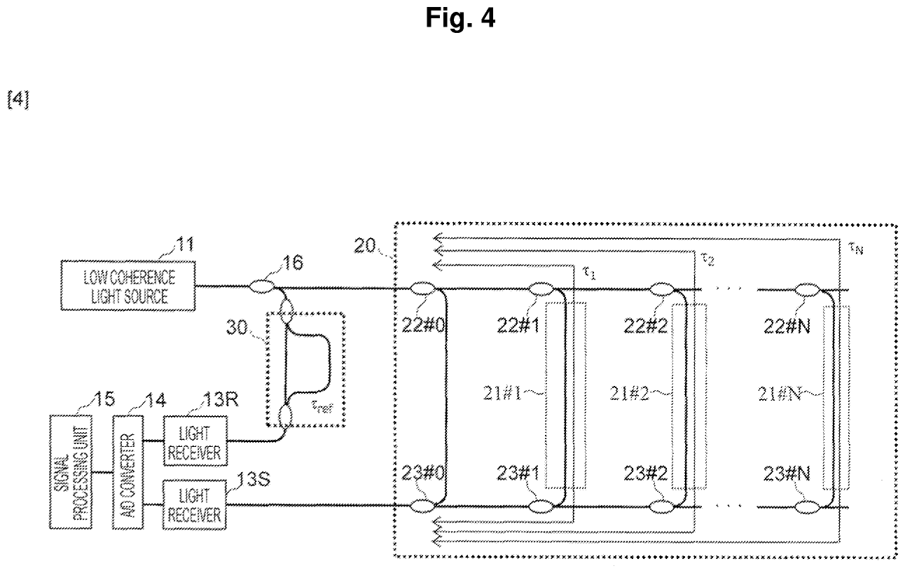

In the present embodiment, an implementation procedure is the same as that of Embodiment 1, and a device configuration for use is different from that of Embodiment 1. FIG. 4 is a block diagram illustrating a device configuration according to the present embodiment. A low coherence light source 11 is used as a light source, and continuous light output from the low coherence light source 11 is branched at an optical coupler 16 and is injected into a sensor interferometer 20 and a reference interferometer 30.

The reference interferometer 30 is a Mach-Zehnder interferometer in which a difference in propagation delay time between optical paths is τ_{ref}. The sensor interferometer 20 includes a plurality of sensor units 21 connected in parallel, and a propagation delay time τ of continuous light transmitting through the sensor interferometer 20 is different for each sensor unit 21. In the present embodiment, the sensor interferometer 20 has a configuration in which the optical fibers are connected in a ladder shape with the optical couplers 22 #1 to 22 #N and 23 #1 to 23 #N, and optical paths of stages of the ladder shape individually correspond to the sensor units 21 #1 to 21 #N.

In the sensor interferometer 20 of FIG. 4, the differences in propagation delay time during which light emitted from the optical coupler 22 #0 at an upper left end individually transmits through the sensor units 21 #1 to 21 #N and is injected into the optical coupler 23 #0 at a lower left end are integral multiples of τ_{ref}, and do not overlap each other in the plurality of sensor units 21 (Mⱼ≠Mᵢ (j≠i)). Continuous light transmitted through the sensor interferometer 20 and continuous light transmitted through the reference interferometer 30 are respectively received by individual light receivers 13S and 13R, and are converted into electric signals. The light reception signals that are the electric signals obtained by the conversion are individually converted into digital signals by an A/D converter 14, and are transmitted to a signal processing unit 15. Note that, as the low coherence light source 11 used in the device configuration, a light source having a coherence time shorter than τ_{ref} is used.

The other implementation procedure is performed in accordance with the flowchart of FIG. 3 similarly to Embodiment 1.

The signal processing unit 15 of the present disclosure can also be implemented on a computer and in a program, and the program can be recorded on a recording medium or be provided through a network.

### INDUSTRIAL APPLICABILITY

The present disclosure can be applied to information and communication industries.

### REFERENCE SIGNS LIST

11 Low coherence light source
12 High coherence light source
13 Light receiver
14 A/D converter
15 Signal processing unit
16, 22 #0 to 22 #N, 23 #0 to 23 #N, 32, 33 Optical coupler
20 Sensor interferometer
30 Reference interferometer

1. An optical fiber sensing device comprising:
a light source for outputting continuous light;
an optical coupler for branching the continuous light;
a reference interferometer, into which continuous light branched by the optical coupler is injected, for producing a predetermined difference T_{ref} in propagation delay time in the continuous light;
a sensor interferometer, into which continuous light branched by the optical coupler is injected, including a plurality of connected Mach-Zehnder interferometers for producing, in the continuous light, differences in propagation delay time that correspond to integer multiples of the predetermined difference T_{ref} in propagation delay time and are different from each other, the Mach-Zehnder interferometers having unilateral optical paths functioning as sensor units; and
a signal processing unit for performing signal processing by using a light reception signal I(t) which is obtained by receiving light transmitting through the sensor interferometer and a reference signal I_{ref-1}(t) which is obtained by receiving light transmitting through the reference interferometer,
wherein the signal processing unit
calculates a reference signal I_{ref-j}(t) corresponding to a j-th (j is a natural number) sensor unit of the sensor units by using the reference signal I_{ref-1}(t),
calculates a cross-correlation Rⱼ between the light reception signal I(t) and the reference signal I_{ref-j}(t), and
detects a change in the j-th sensor unit by using a change in the cross-correlation Rⱼ.

2. The optical fiber sensing device according to claim 1,
wherein the signal processing unit
calculates a phase X₁(t) of the continuous light at the predetermined difference T_{ref} in propagation delay time by using the reference signal I_{ref-1}(t),
calculates, on condition that the difference in propagation delay time of the j-th sensor unit is Mⱼ times T_{ref}, a phase X_{Mj}(t) corresponding to the j-th sensor unit by summing up Mⱼ waveforms obtained by shifting X₁(t) by T_{ref}, and
calculates the reference signal I_{ref-j}(t) corresponding to the j-th sensor unit by using the phase X_{Mj}(t).

3. The optical fiber sensing device according to claim 2,
wherein the signal processing unit
calculates, as the reference signal I_{ref-j}(t), a cosine wave having the phase X_{Mj}(t) as a phase component, and
calculates the cross-correlation Rⱼ between the light reception signal I(t) and the reference signal I_{ref-j}(t) by using the cosine wave.

4. The optical fiber sensing device according to claim 1,
wherein the predetermined difference T_{ref} in propagation delay time of the reference interferometer is longer than a coherence time of the continuous light.

5. The optical fiber sensing device according to claim 1,
wherein the sensor interferometer includes a plurality of Mach-Zehnder interferometers connected in series,
the sensor units are unilateral optical paths in the Mach-Zehnder interferometers, and
differences in propagation delay time of the sensor units included in the plurality of Mach-Zehnder interferometers are different from each other.

6. The optical fiber sensing device according to claim 1,
wherein the sensor interferometer includes a plurality of sensor units connected in parallel, and
a propagation delay time of the continuous light transmitting through the sensor interferometer is different for each of the sensor units.

7. The optical fiber sensing device according to claim 1,
wherein the change in the sensor unit is a change in temperature or distortion of the j-th sensor unit.

8. An optical fiber sensing method comprising:
branching continuous light from a light source;
injecting the branched continuous light into a reference interferometer producing a predetermined difference T_{ref} in propagation delay time in the continuous light;
injecting the branched continuous light into a sensor interferometer, including a plurality of connected Mach-Zehnder interferometers, producing, in the continuous light, differences in propagation delay time that correspond to integer multiples of the predetermined difference T_{ref} in propagation delay time and are different from each other, the Mach-Zehnder interferometers having unilateral optical paths functioning as sensor units; and
detecting, by a signal processing unit, a change in the sensor units by using a light reception signal I(t) which is obtained by receiving light transmitting through the sensor interferometer and a reference signal I_{ref-1}(t) which is obtained by receiving light transmitting through the reference interferometer,
wherein the signal processing unit
calculates a reference signal I_{ref-j}(t) corresponding to a j-th sensor unit by using the reference signal I_{ref-1}(t),
calculates a cross-correlation Rⱼ between the light reception signal I(t) and the reference signal I_{ref-j}(t), and
detects a change in the j-th sensor unit by using a change in the cross-correlation Rⱼ.
